(19) United States
(12) Patent Application Publication
(10) Pub. No.: US 2024/0357444 A1
(43) Pub. Date: Oct. 24, 2024

(54) RADIO LINK CAPABILITY EXPOSURE FOR ULTRA-RELIABLE LOW-LATENCY COMMUNICATIONS AND TIME SENSITIVE COMMUNICATIONS

(71) Applicant: Nokia Technologies Oy, Espoo (FI)

(72) Inventors: Zexian LI, Espoo (FI); Sean KELLEY, Naperville, IL (US); Ping-Heng KUO, Cambridge (GB); Guillermo POCOVI, Aalborg (DK); Markus Sakari ISOMÄKI, Espoo (FI); Keeth Saliya Jayasinghe LADDU, Espoo (FI); Devaki CHANDRAMOULI, Dallas, TX (US)

(21) Appl. No.: 18/693,281

(22) PCT Filed: Sep. 30, 2022
(86) PCT No.: PCT/EP2022/077316

§ 371 Date: Mar. 19, 2024

Related U.S. Application Data
(60) Provisional application No. 63/254,672, filed on Oct. 12, 2021.

(51) Int. Cl. H04W 36/00

(52) U.S. Cl. CPC H04W 36/0079; H04W 36/0058; H04W 36/0085

(57) ABSTRACT

Systems, methods, apparatuses, and computer program products for radio link capability exposure for ultra-reliable low-latency communications (URLLC) and time sensitive communications (TSC). A method may include receiving, from a core network element, configuration of a reliability threshold for sending a failure report and/or a radio link capability report. The method may also include, when the reliability threshold is reached, sending a failure report to the core network element indicating that a required reliability cannot be fulfilled. The method may further include receiving instructions, from the core network element, to perform an action to address the unfulfilled reliability.

### FIELD

Some example embodiments may generally relate to mobile or wireless telecommunication systems, such as Long Term Evolution (LTE) or fifth generation (5G) new radio (NR) access technology, or other communications systems. For example, certain example embodiments may relate to apparatuses, systems, and/or methods for radio link capability exposure for ultra-reliable low-latency communications (URLLC) and time sensitive communications (TSC).

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Some example embodiments may be directed to a method. The method may include receiving, from a core network element, configuration of a reliability threshold for sending a failure report and/or a radio link capability report. The method may also include, when the reliability threshold is reached, sending a failure report to the core network element indicating that a required reliability cannot be fulfilled. The method may further include receiving instructions, from the core network element, to perform an action to address the unfulfilled reliability.

Other example embodiments may be directed to an apparatus. The apparatus may include at least one processor and at least one memory including computer program code. The at least one memory and computer program code may also be configured to, with the at least one processor, cause the apparatus at least to receive, from a core network element, configuration of a reliability threshold for sending a failure report and/or a radio link capability report. The apparatus may also be caused to, when the reliability threshold is reached, send a failure report, to the core network element, indicating that a required reliability cannot be fulfilled. The apparatus may further be caused to receive instructions, from the core network element, to perform an action to address the unfulfilled reliability.

Other example embodiments may be directed to an apparatus. The apparatus may include means for receiving, from a core network element, configuration of a reliability threshold for sending a failure report and/or a radio link capability report. The apparatus may also include means for, when the reliability threshold is reached, sending a failure report to the core network element indicating that a required reliability cannot be fulfilled. The apparatus may further include means for receiving instructions, from the core network element, to perform an action to address the unfulfilled reliability.

In accordance with other example embodiments, a non-transitory computer readable medium may be encoded with instructions that may, when executed in hardware, perform a method. The method may include receiving, from a core network element, configuration of a reliability threshold for sending a failure report and/or a radio link capability report. The method may also include, when the reliability threshold is reached, sending a failure report to the core network element indicating that a required reliability cannot be fulfilled. The method may further include receiving instructions, from the core network element, to perform an action to address the unfulfilled reliability.

Other example embodiments may be directed to a computer program product that performs a method. The method may include receiving, from a core network element, configuration of a reliability threshold for sending a failure report and/or a radio link capability report. The method may also include, when the reliability threshold is reached, sending a failure report to the core network element indicating that a required reliability cannot be fulfilled. The method may further include receiving instructions, from the core network element, to perform an action to address the unfulfilled reliability.

Other example embodiments may be directed to an apparatus that may include circuitry configured to receive, from a core network element, configuration of a reliability threshold for sending a failure report and/or a radio link capability report. The apparatus may also include circuitry configured to, when the reliability threshold is reached, send a failure report, to the core network element, indicating that a required reliability cannot be fulfilled. The apparatus may further include circuitry configured to receive instructions, from the core network element, to perform an action to address the unfulfilled reliability.

Certain example embodiments may be directed to a method. The method may include receiving reliability criteria from a core network element. The method may also include configuring a reliability threshold based on the reliability criteria. The method may further include sending, to a network element, the configuration of the reliability threshold for sending a failure report and/or a radio link capability report. In addition, the method may include receiving a failure report, from the network element, indicating that a required reliability cannot be fulfilled. Further, the method may include sending, in response to the failure report, instructions to the network element to perform an action to address the unfulfilled reliability.

Other example embodiments may be directed to an apparatus. The apparatus may include at least one processor and at least one memory including computer program code. The at least one memory and computer program code may be configured to, with the at least one processor, cause the apparatus at least to receive reliability criteria from a core network element. The apparatus may also be caused to configure a reliability threshold based on the reliability criteria. The apparatus may further be caused to send, to a network element, the configuration of the reliability threshold for sending a failure report and/or a radio link capability report. In addition, the apparatus may be caused to receive a failure report, from the network element, indicating that a required reliability cannot be fulfilled. Further, the apparatus may be caused to send, in response to the failure report, instructions to the network element to perform an action to address the unfulfilled reliability.

Other example embodiments may be directed to an apparatus. The apparatus may include means for receiving reliability criteria from a core network element. The apparatus may also include means for configuring a reliability threshold based on the reliability criteria. The apparatus may further include means for sending, to a network element, the configuration of the reliability threshold for sending a failure report and/or a radio link capability report. In addition, the apparatus may include means for receiving a failure report, from the network element, indicating that a required reliability cannot be fulfilled. Further, the apparatus may include means for sending, in response to the failure report, instructions to the network element to perform an action to address the unfulfilled reliability.

In accordance with other example embodiments, a non-transitory computer readable medium may be encoded with instructions that may, when executed in hardware, perform a method. The method may include receiving reliability criteria from a core network element. The method may also include configuring a reliability threshold based on the reliability criteria. The method may further include sending, to a network element, the configuration of the reliability threshold for sending a failure report and/or a radio link capability report. In addition, the method may include receiving a failure report, from the network element, indicating that a required reliability cannot be fulfilled. Further, the method may include sending, in response to the failure report, instructions to the network element to perform an action to address the unfulfilled reliability.

Other example embodiments may be directed to a computer program product that performs a method. The method may include receiving reliability criteria from a core network element. The method may also include configuring a reliability threshold based on the reliability criteria. The method may further include sending, to a network element, the configuration of the reliability threshold for sending a failure report and/or a radio link capability report. In addition, the method may include receiving a failure report, from the network element, indicating that a required reliability cannot be fulfilled. Further, the method may include sending, in response to the failure report, instructions to the network element to perform an action to address the unfulfilled reliability.

Other example embodiments may be directed to an apparatus that may include circuitry configured to receive reliability criteria from a core network element. The apparatus may also include circuitry configured to configure a reliability threshold based on the reliability criteria. The apparatus may further include circuitry configured to send, to a network element, the configuration of the reliability threshold for sending a failure report and/or a radio link capability report. In addition, the apparatus may include circuitry configured to receive a failure report, from the network element, indicating that a required reliability cannot be fulfilled. Further, the apparatus may include circuitry configured to send, in response to the failure report, instructions to the network element to perform an action to address the unfulfilled reliability.

### BRIEF DESCRIPTION OF THE DRAWINGS:

For proper understanding of example embodiments, reference should be made to the accompanying drawings, wherein:

FIG. 1(a) illustrates an example user equipment-user equipment (UE-UE) communication.

FIG. 1(b) illustrates an example conventional communication.

FIG. 2 illustrates an example signaling diagram for reliability threshold-based radio capability report, according to certain example embodiments.

FIG. 3 illustrates a table of an example format for radio link capability report (RLC), according to certain example embodiments.

FIG. 4 illustrates an example signaling diagram for RLCR reporting based on a request, according to certain example embodiments.

FIG. 5 illustrates an example flow diagram of a method, according to certain example embodiments.

FIG. 6 illustrates an example flow diagram of another method, according to certain example embodiments.

FIG. 7(a) illustrates an apparatus, according to certain example embodiments.

FIG. 7(b) illustrates another apparatus, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for radio link capability exposure for URLLC and TSC communications.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

Efficient support of various Industrial Internet of Things (IIoT)/URLLC use cases has been of interest in 3rd Generation Partnership Project (3GPP) since the first release of the 5G design. 5G URLLC and TSC communications have been envisioned as key enablers to support many new use cases not traditionally supported in mobile networks such as factory automation or audio/video production, control of Unmanned Aerial Vehicles (UAVs, also known as drones), gaming or Augmented/Virtual Reality (AR/VR).

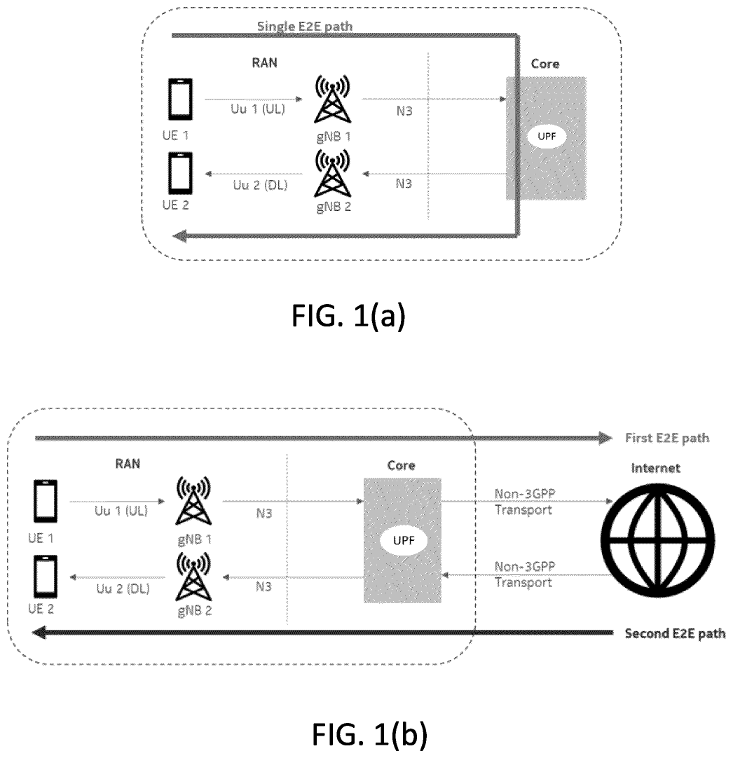

3GPP may include a concept of user equipment-user equipment (UE-UE) communication. For instance, FIG. 1(a) illustrates an example UE-UE communication, and FIG. 1(b) illustrates an example conventional communication. As can be seen from FIGS. 1(a) and 1(b), the difference between the UE-UE communication (FIG. 1(a)) and the conventional communication (FIG. 1(b)) is that the two UE-UPF (User equipment-User Plane Function) connections (e.g. the links from UE to UPF via gNB) are not independent anymore as shown in FIG. 1(a), and in some sense they may be seen to form a single end-to-end (E2E) path. As one example, in a case with conventional communication, and assuming 10 ms UE-UE latency requirement with 99.999% reliability, the network or the requesting application would split the 10 ms equally to the first link and the second link (i.e., 5 ms per link and the two links are treated separately). However, in the case of UE-UE communication and the knowledge of achievable performance (e.g., latency and/or reliability) for each link, the network may treat these two links jointly, or as one E2E link between two UEs. Further, in this scenario, the allocated delay budget for each link may be optimized (e.g., 7 ms for the first link, which is with bad channel quality, and 3 ms for the second link).

As illustrated in FIG. 1(b), when establishing a data communication link between two UEs in 5G, two independent quality of service (QoS) flows may be established by the network. For example, UE1 protocol data unit (PDU) session in uplink (UL) and UE2 PDU session in downlink (DL). The overall system efficiency may be improved with the introduction of UE-UE communication when the two links can be treated jointly, especially if the achievable performance at each link can be known at the network side.

Another example scenario may include the unmanned aerial vehicle (UAV) control or unmanned aerial systems (UAS) where network exposure capabilities may be used for UAS control. In certain cases, QoS exposure capability (including the reliability aspect) of 5GS may become important in order to support efficient UAV control or UAS.

QoS exposure capability is available in 3GPP. However, the available QoS exposure capability is mainly for periodic traffic and deterministic QoS. The time sensitive communication assistance information (TSCAI), which describes traffic characteristics (e.g., flow direction, periodicity, burst arrival time, survival time, etc.), may be used by the radio access network (RAN) to optimize scheduling radio resource for periodic traffic. However, there has not been much focus on reliability capabilities, which may be important for supporting various applications with strict reliability requirements. Reliability may be defined as the success probability of transmitting a packet of X bytes within a certain time window. Reliability can also be defined in terms of additional QoS parameters on top of packet delay budget (PDB) and packet error rate (PER), for example survival time, which is defined as the time that an application consuming a communication service may continue to operate without an anticipated message. The survival time can be expressed as a period or, especially with periodic traffic, as the maximum number of consecutive incorrectly received and/or delayed or lost messages.

QoS exposure may be relevant to UE-UE communication where the issue of UE-UE QoS optimization from the core network (CN) traffic forwarding perspective at the common UPF has been enabled. However, aspects related to RAN reliability exposure have not been considered. Moreover, the necessary support of reporting the achievable capability, especially considering the reliability aspects that are expected as the next step of development, have not been considered. As such, there is a gap concerning the 3GPP RAN to support reliability exposure, and there has been little focus concerning the reliability exposure aspect over RAN in the case of supporting UE-UE communication or UAS. There has also been a lack of focus on how to obtain information of the overall UE-UE link quality, and how the network can leverage such radio link capability information for optimized RAN operation. Accordingly, certain example embodiments may fill this gap with a radio link capability report (RLCR) approach, reporting mechanisms, and related procedures at different network entities.

Certain example embodiments may provide a RLCR method, reporting mechanisms (e.g., reliability criteria/threshold configuration, reliability threshold-based reporting), and the new behaviors at different network entities to enable proactive and reactive action by the network and the application function (AF) to avoid performance degradation in terms of reliability. In particular, as discussed herein, certain example embodiments may provide reliability criteria configuration. For instance, the AF may request a certain reliability criteria (e.g., survival time, i.e. consecutive “n” packet failure within “t” ms on top of regular QoS parameters including, for example, PER, reliability cannot be met over a period of averaging window) that results in the network to influence UE route selection policies (URSP) in the UE for setting up redundant session, packet data convergence protocol (PDCP) duplication, dual connectivity (DC) setup and so on. Based on the reliability criteria, selecting the appropriate reliability threshold, which can be used for triggering the gNB to report failure of delivering certain reliability or providing updated radio link capability. The reliability criteria are derived based on the service performance requirement. As one example, based on the survival time requirement of certain application, the reliability criteria could be defined as consecutive “4” packet failure (i.e. packet decoding error or packet loss or packet delivered after packet delay budget, PDB). Based on the reliability criteria from certain application, reliability threshold can be defined as consecutive “4” packet failure. With this example, the gNB is triggered to report the failure of meeting the required reliability. As another example of defining reliability threshold, it is also possible that the reliability criteria and the reliability threshold are not the same. With the same definition of reliability criteria as above, another example to define reliability threshold is consecutive “3” packet failure.

In certain example embodiments, when a reliability threshold is reached, the gNB may report to a session management function (SMF) (or another core network element), for example, failure to meet the required reliability. In other example embodiments, the gNB may also report the updated capability. Once the report from the gNB is received, the SMF (or another core network element) may indicate actions to be taken at the gNB/UE side (e.g., activating additional redundancy path) to boost the reliability.

According to certain example embodiments, radio link capability may be derived or measured at the gNB and be defined as the achievable reliability within certain over the air latency budget in terms of, for example, communication direction (downlink (DL)/uplink (UL)), transport block (TB)/packet size, and/or system load. In some example embodiments, depending on the configuration, a single entry or multiple entries per direction over a Uu interface may be included. Depending on the deployment scenarios, the radio link capability for UL and DL may differ significantly. Further, in certain example embodiments, the derived radio link capability may take into account UE capability, UE status (e.g., static vs mobile), and different ways for enhanced performance. Examples of what the derived radio link capability can take into account may include, but is not limited to, operated carrier frequency, available bandwidth, device type/capabilities (e.g., number of antennas, single/multi-panel UEs), high/low-speed UE, modulation coding scheme (MCS) selection, Tx power, different ways of diversity (e.g., time including hybrid automatic repeat request (HARQ)/automatic repeat request (ARQ)/frequency/spatial), PDCP duplication, carrier aggregation, dual-/multi-connectivity, and others.

In certain example embodiments, in the case with UE-UE communication, the gNB and/or the SMF may not know that there is an ongoing UE-UE communication between the two UEs; but a user plane function (UPF) may know. Thus, in this case, the UPF may correspond to the network entity that can exchange the link quality information, which means that the radio capability reports from the gNB need to be included in the U-plane (e.g., GTP-U header towards UPF). Considering the potential future development of UE-UE communication, certain example embodiments may also consider the scenario that SMF is aware of the UE-UE communication based on the UPF report over N4 towards the SMF or information from AF, and how much radio capability information can be used to optimize the E2E link.

According to certain example embodiments, in the establishment phase of the UE-UE communication, SMF (or another CN entity) may identify the weaker link (i.e. the link achieving worse reliability over the Uu interface for the same data packet or stream) between the two Uu links, for example, after checking the received RLCR. The SMF (or another CN entity) may also inform “the weaker capability” to the other link and instruct the gNB to act appropriately to ensure that the required reliability is met for the UE-UE communication. In other example embodiments, the SMF (or another CN entity) may use the received RLCRs to adjust the QoS requirement accordingly for each UE by sending updated QoS parameters to the gNB for each UE. This may ensure that the overall QoS and reliability for the UE-UE QoS requirement continues to be met. In further example embodiments, the gNB with the “better link reliability” (i.e. the link achieving better reliability over the Uu interface for the same data packet) may adjust the allocated resource accordingly based on the updated QoS parameters request received from the SMF (or another CN entity) (e.g., based on the maximal TB size (to fulfill the QoS requirement) from the “weaker” link).

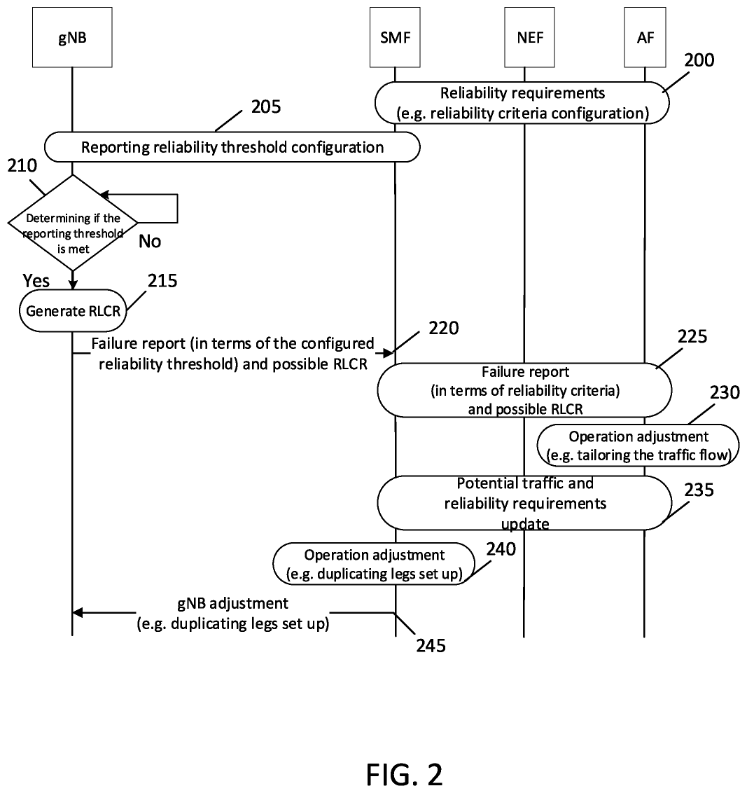

FIG. 2 illustrates an example signaling diagram for reliability threshold-based radio capability report, according to certain example embodiments. In certain example embodiments, once the configured threshold is reached, the gNB may report failure of fulfilling the requested reliability and may send updated RLCR. When the SMF receives the updated RLCR, the SMF may forward such information to the AF via a network exposure function (NEF). The SMF and/or the AF may then take proper measures including, for example, setting up a duplicate session or tailor the traffic flow according to the latest radio link capability.

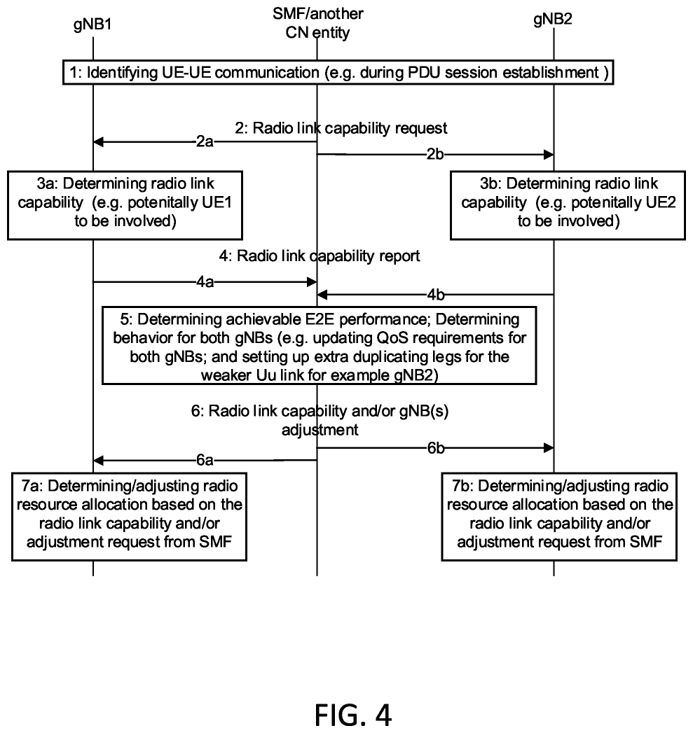

As illustrated in FIG. 2, at 200, the AF may set certain reliability requirements (e.g., reliability criteria configuration), and forward the reliability requirements to the SMF via the NEF. At 205, the SMF may configure a reliability threshold configuration based on the reliability requirements and forward the reporting reliability threshold configuration to the gNB. As discussed in the example embodiments below, the gNB may correspond to gNB1 or gNB2 in FIG. 4. At 210, the gNB may monitor the link quality and achievable reliability and may determine whether the reporting threshold has been met. If the gNB determines that the configured threshold is met, at 215 the gNB may generate the RLCR based on the received reliability criteria configuration. At 220, once the configured threshold is reached, the gNB may report failure of fulfilling the requested reliability and may also send a RLCR to the SMF. At 225, the SMF may forward the failure report (in terms of reliability threshold) and the updated RLCR (if sent) to the AF via the NEF. At 230, the AF may perform an operation adjustment (e.g., tailoring the traffic flow) based on the received failure report and/or RLCR. In other example embodiments, the SMF may perform an operation adjustment based on the failure report and/or RLCR. At 235, the AF may forward an update to the SMF via the NEF regarding potential traffic and reliability requirements update. At 240, the SMF may perform an operation adjustment (e.g., setting up duplicate session/duplicating legs setup). At 245, the SMF may transmit instructions to the gNB to perform an adjustment (e.g., setting up a duplicate session; duplicating legs setup).

In other example embodiments, actions to be taken at the gNB side may be configured by the SMF beforehand as well (e.g., the SMF may require the periodic reporting from UE-1's gNB-1 and UE-2's gNB-2). That is, once the reporting threshold is reached, after the gNB sends a status report (which may or may not include a failure report) to the SMF, the SMF may confirm the updated behavior at the gNB side. In certain example embodiments, such reliability threshold-based reporting may be configured to selected applications including, for example, URLLC/UAV control etc., not necessarily for all different applications. In certain example embodiments, the gNB may be configured to send a status report (which may or may not include a failure report) to the SMF in a periodic manner.

According to certain example embodiments, there may be several options for reporting the radio capability. For instance, in one example embodiment, the reporting may be characterized as a type of reactive reporting where, for example, the reporting is event-triggered as shown in FIG. 2. In this case, based on the reliability criteria received from the AF, the SMF may configure the reliability threshold for reporting to the gNB. If the threshold is reached, the gNB may send a failure report to the SMF to indicate that the required reliability cannot be fulfilled. In addition, the gNB may send the (updated) radio capability report (i.e., RLCR).

According to certain example embodiments, the reliability threshold may be configured as a static threshold. Alternatively, in other example embodiments, the reliability threshold may be dynamically updated. For instance, the threshold may be updated periodically, or it may be updated based on an event trigger (e.g., packet loss in one link in case with UE-UE communication where the indication for UE-UE communication should be included as part of a U-plane header between gNB and UPF). According to certain example embodiments, the reliability threshold can be defined in terms of survival time. For instance, as an illustrated example, the application can tolerate up to 3 consecutive packet error/loss. Then 3 consecutive packet error/loss can be configured as a reliability threshold. In this case 4 or more consecutive packet error/loss may trigger gNB reporting.

In other example embodiments, the radio capability may be proactively reported. For instance, the radio capability may be reported periodically. In this case, the gNB may send the report in a proactive manner without any explicit/implicit request from the SMF. In some example embodiments, this type of reporting may be desired for a relatively static environment, and the required reporting frequency is not high to avoid resulting in too much signaling overhead.

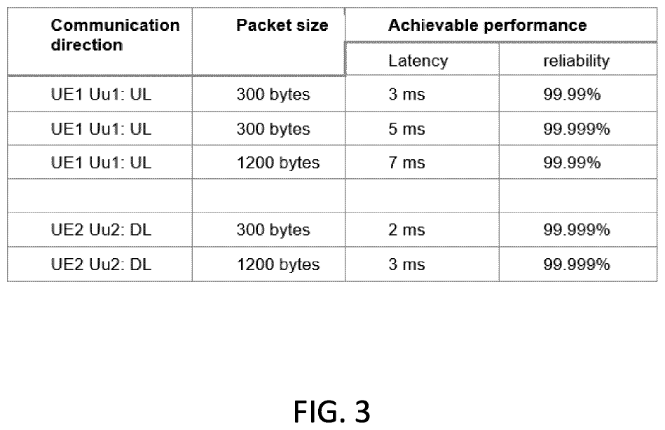

According to certain example embodiments, the RLCR may be defined according to the table illustrated in FIG. 3. In particular, FIG. 3 illustrates a table of an example format for RLCR, according to certain example embodiments. In the context of FIG. 3, it may be assumed that the packets are sent from UE1 to UE2. In this example, the gNB may build the RLCR including the elements of communication direction, packet/TB size and achievable performance considering both latency and reliability. Based on the information from the table in FIG. 3, the SMF can derive the achievable UE-UE QoS information. For instance, for a packet size of 300 bytes, the SMF can estimate that 99.999% of the packets are within 7 ms radio latency (covering both Uu1 and Uu2). With 1,200 bytes, the SMF can estimate that 99.99% of the packets are within 10 ms or shorter radio latency (covering both Uu1 and Uu2). SMF can then apply its knowledge of the backhaul network latency and reliability between the gNBs and the UPF to determine how much they add up on top of the combined radio latency and reliability.

According to certain example embodiments, with the assumption that the SMF is aware of the UE-UE communication, during the establishment phase of the UE-UE communication, the SMF (or another CN entity) may request the gNB(s) to send RLCR for the interested UEs, and identify the weaker link among the two Uu links. This may be accomplished, for example, after analyzing the received RLCR. Then, different actions may be taken. For example the AF may request for a certain reliability criterion to the SMF (e.g., via the NEF), which may trigger the SMF to register for notification with the gNB when the requested reliability criteria (e.g., packet error rate (PER) over an averaging period) cannot be fulfilled.

In other example embodiments, a different action may be taken, which may include in the establishment phase of the UE-UE communication, the SMF (or another CN entity) identifying the weaker link among the two Uu links. The identification of the weaker link may occur after checking the received RLCR, and informing “the weaker capability” to the other link. The SMF (or another CN entity) may also require the gNB to act appropriately to ensure the required reliability is met for the UE-UE communication. In other example embodiments, the SMF (or another CN entity) may use the received RLCR(s) to adjust the QoS requirement accordingly for each UE by sending updated QoS parameters to the gNB for each UE. This may then ensure that the overall QoS and reliability for the UE-UE QoS requirement continues to be met.

According to certain example embodiments, a further action that may be taken after the SMF (or another CN entity) analyzes the RLCR may include receiving RLCR(s) to adjust the overall UE-UE QoS requirement accordingly. Here, it may be assumed that the entire UE-UE latency is 10 ms covering both Uu1 and Uu2 on top of the backhaul transmission. For simplicity, it may be assumed that the CN latency is “0”, then without radio capability information and according to 3GPP Rel-17 specification, the time budget allocated to Uu1 and Uu2 may be the same (i.e., 5 ms each). However, when the SMF or the AF has such information as shown in FIG. 3, the unbalanced latency budget may be allocated (e.g., Uu1 allocated with 7 ms, while Uu2 allocated with 3 ms). In this way, it may be possible to achieve better performance rather than equal distribution between the two Uu links.

In certain example embodiments, the gNB(s) may optimize radio resource usage during the operation of UE-UE communication as well. For example, when one (e.g., Uu2) of the link quality changes (e.g., below a threshold or “the weaker capability” needs to be updated), the gNB (e.g., gNB2) may inform the SMF (or another CN entity) about the change, and the SMF (or another CN entity) may inform the other end (e.g., gNB1) as well.

FIG. 4 illustrates an example signaling diagram for RLCR reporting based on a request, according to certain example embodiments. At 1, the SMF (or another CN entity) may identify the UE-UE communication. For example, during PDU session establishment, the network entity (AF, SMF or another CN entity) can identify UE-UE communication by checking if the involved UEs belong to the same UPF or not. In case both UEs are connected to the same UPF, the overall communication can be handled as UE-UE communication. At 2, once the UE-UE communication has been identified, the SMF (or another CN entity) may send RLCR requests to gNB1 (at 2a) and gNB2 (at 2b). At 3a and 3b, after receiving the RLCR request, the gNBs (e.g., gNB1 and gNB2) may determine the achievable radio link capability for the UEs and generate RLCR. At 4, gNB1 (at 4a) and gNB2 (at 4b) may send the RLCR to the SMF (or another CN entity). At 5, the SMF (or another CN entity) may determine the achievable E2E performance based on the received RLCRs from both gNB1 and gNB2 (e.g., Uu1 and Uu2 in FIG. 1), and the necessary adjustments at the gNB(s). At 6, the SMF (or another CN entity) may inform gNB1 (at 6a) and gNB2 (at 6b) about the radio link capability decision and/or adjustment actions (e.g., setting up duplicating legs). At 7a and 7b, gNB1 and gNB2 may determine/adjust the allocated radio resource based on the received information from the SMF (or another CN entity) at 6a and 6b.

According to certain example embodiments, the concepts described herein may be applicable in UE-network communications and UE-UE communications (e.g., to accurately know what is achievable beforehand). In other example embodiments, concepts described herein may be applicable where 5GS is acting as an Ethernet Bridge and TSN AF monitoring the quality of the PDU sessions used by the bridge ports. If the TSN AF is able to obtain accurate performance information about the PDU sessions, it may be able to influence Bridge's traffic forwarding (e.g., forwarding traffic via another port, also updating this information to other Bridges). Furthermore, the RLCR concepts of certain example embodiments may help monitor radio performance.

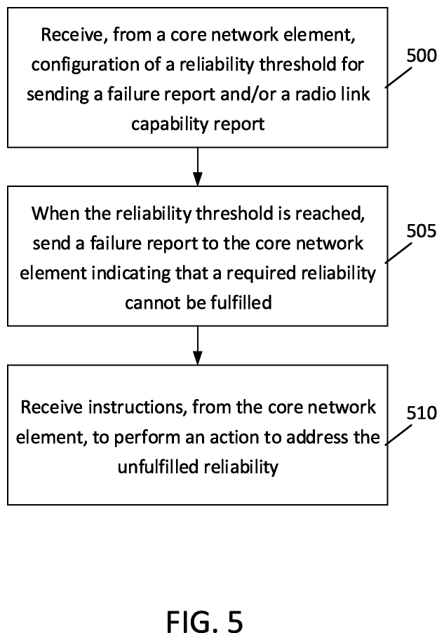

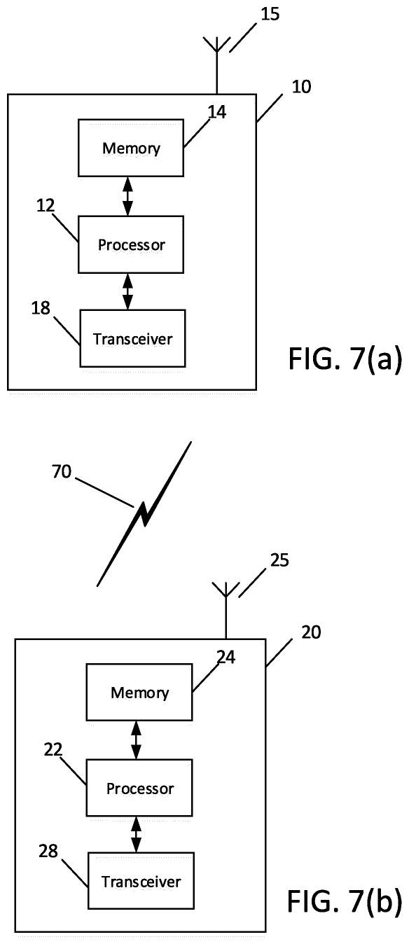

FIG. 5 illustrates an example flow diagram of a method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by a gNB similar to one of apparatuses 10 or 20 illustrated in FIGS. 7(a) and 7(b).

According to certain example embodiments, the method of FIG. 5 may include, at 500, receiving, from a core network element, configuration of a reliability threshold for sending a failure report and/or a radio link capability report. At 505, the method may include, when the reliability threshold is reached, sending a failure report to the core network element indicating that a required reliability cannot be fulfilled. At 510, the method may include receiving, instructions from the core network element, to perform an action to address the unfulfilled reliability.

According to certain example embodiments, the failure report may include an indication that it is infeasible to further boost a reliability at a radio access network side. According to other example embodiments, the method may also include generating the radio link capability report based on the reliability threshold configuration. According to some example embodiments, the method may further include sending the radio link capability report along with the failure report. According to other example embodiments, the radio link capability report may be sent periodically without an explicit request from the core network element. In certain example embodiments, the method may also include executing the instructions to perform the action to address the unfulfilled reliability. In some example embodiments, the action may include at least one of setting up duplicating legs, setting up a duplicate session, adjusting a duplication setting, adjusting radio resource control configurations, adjusting quality of service parameters, adjusting allocation or parameterization of radio resources, and adjusting allocation or parameterization of computing resources. According to other example embodiments, the RAN may turn the duplication setting on or off to boost reliability.

According to certain example embodiments, the reliability threshold may be configured as a static threshold, or as a dynamic threshold that is dynamically updated. According to some example embodiments, the method may further include receiving a request from the core network element for the failure report and/or the radio link capability report. According to other example embodiments, the method may also include determining an achievable radio link capability in response to the request. In certain example embodiments, the method may further include sending the radio link capability report to the core network element including information on the achievable radio link capability.

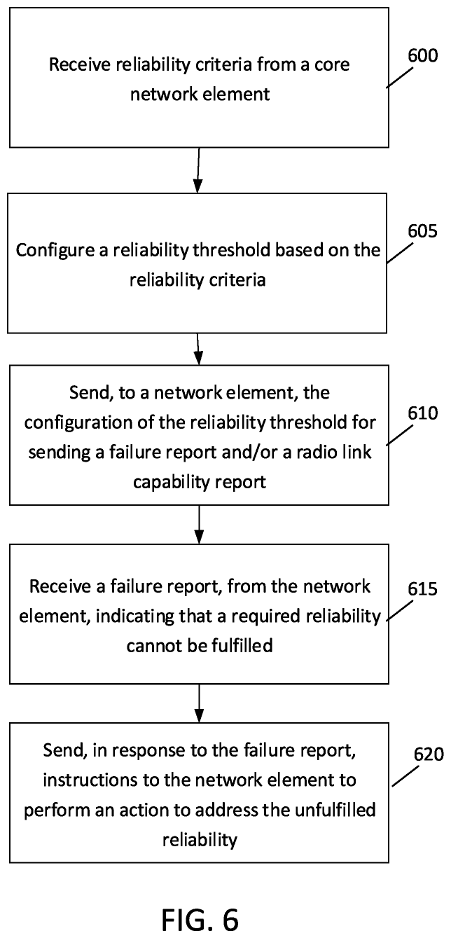

FIG. 6 illustrates an example flow diagram of another method, according to certain example embodiments. In an example embodiment, the method of FIG. 6 may be performed by a network entity, or a group of multiple network elements in a 3GPP system, such as LTE or 5G-NR. For instance, in an example embodiment, the method of FIG. 6 may be performed by a core network element such as, for example, an SMF, AF, or other similar core network elements similar to one of apparatuses 10 or 20 illustrated in FIGS. 7(a) and 7(b).

According to certain example embodiments, the method of FIG. 6 may include, at 600, receiving reliability criteria from a core network element. At 605, the method may include configuring a reliability threshold based on the reliability criteria. At 610, the method may include sending, to a network element, the configuration of the reliability threshold for sending a failure report and/or a radio link capability report. At 615, the method may include receiving a failure report, from the network element, indicating that a required reliability cannot be fulfilled. At 620, the method may include sending, in response to the failure report, instructions to the network element to perform an action to address the unfulfilled reliability.

According to certain example embodiments, the action may include at least one of setting up duplicating legs, setting up a duplicate session, adjusting a duplication setting, adjusting radio resource control configurations, adjusting quality of service parameters, adjusting allocation or parameterization of radio resources, and adjusting allocation or parameterization of computing resources. According to some example embodiments, the method may also include receiving the radio link capability report along with the failure report. According to other example embodiments, the radio link capability report may be received periodically without an explicit request for the radio link capability report. In certain example embodiments, the method may also include identifying a communication between a first user equipment and a second user equipment. In some example embodiments, the method may further include sending a request for the radio link capability report to a network element serving the first user equipment, and to a network element serving the second user equipment. In other example embodiments, the method may also include receiving respective radio link capability reports from the network element serving the first user equipment and from the network element serving the second user equipment. In further example embodiments, the method may include identifying, based on the respective radio link capability reports, a weak communication link between a communication link of the first user equipment and a communication link of the second user equipment.

According to certain example embodiments, the method may further include adjusting, based on the respective radio link capability reports, a quality of service requirement for the first user equipment and the second user equipment by sending updated quality of service parameters to the network elements serving the first user equipment, and to the network element serving the second user equipment. Alternatively, in other example embodiments, the method may include adjusting an overall quality of service requirement for the communication between the first user equipment and the second user equipment. In certain example embodiments, the method may also include determining, based on the weak communication link, an achievable end-to-end performance. In some example embodiments, the reliability threshold may be configured as a static threshold, or a dynamic threshold that is dynamically updated.

FIG. 7(a) illustrates an apparatus 10 according to certain example embodiments. In certain example embodiments, the apparatus 10 may be a node or element in a communications network or associated with such a network, such as a base station, a Node B, an evolved Node B (eNB), 5G Node B or access point, next generation Node B (NG-NB or gNB), source node/cell, target node/cell, and/or WLAN access point, associated with a radio access network (RAN), such as an LTE network, 5G or NR. It should be noted that one of ordinary skill in the art would understand that apparatus 10 may include components or features not shown in FIG. 7(a).

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 7(a).

As illustrated in the example of FIG. 7(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 7(a), multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-5.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-5.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, from a core network element, configuration of a reliability threshold for sending a failure report and/or a radio link capability report. Apparatus 10 may also be controlled by memory 14 and processor 12 to, when the reliability threshold is reached, send a failure report to the core network element indicating that a required reliability cannot be fulfilled. Apparatus 10 may further be controlled by memory 14 and processor 12 to receive instructions, from the core network element, to perform an action to address the unfulfilled reliability.

FIG. 7(b) illustrates an apparatus 20 according to certain example embodiments. In certain example embodiments, the apparatus 20 may be a node, core network element, or element in a communications network or associated with such a network, such as an SMF, NEF, or AF. It should be noted that one of ordinary skill in the art would understand that apparatus 20 may include components or features not shown in FIG. 7(b).

As illustrated in the example of FIG. 7(b), apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7(b), multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-4 and 6.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1-4 and 6.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to receive reliability criteria from a core network element. Apparatus 20 may also be controlled by memory 24 and processor 22 to configure a reliability threshold based on the reliability criteria. Apparatus 20 may further be controlled by memory 24 and processor 22 to send, to a network element, the configuration of the reliability threshold for sending a failure report and/or a radio link capability report. Further, apparatus 20 may be controlled by memory 24 and processor 22 to receive a failure report, from the network element, indicating that a required reliability cannot be fulfilled. In addition, Apparatus 20 may be controlled by memory 24 and processor 22 to send, in response to the failure report, instructions to the network element to perform an action to address the unfulfilled reliability.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations. Certain example embodiments may be directed to an apparatus that

includes means for performing any of the methods described herein including, for example, means for receiving, from a core network element, configuration of a reliability threshold for sending a failure report and/or a radio link capability report. The apparatus may also include means for, when the reliability threshold is reached, sending a failure report to the core network element indicating that a required reliability cannot be fulfilled. The apparatus may further include means for receiving instructions, from the core network element, to perform an action to address the unfulfilled reliability.

Certain example embodiments may also be directed to an apparatus that includes means for receiving reliability criteria from a core network element. The apparatus may also include means for configuring a reliability threshold based on the reliability criteria. The apparatus may further include means for sending, to the network element, the configuration of the reliability threshold for sending a failure report and/or a radio link capability report. In addition, the apparatus may include means for receiving a failure report, from the network element, indicating that a required reliability cannot be fulfilled. Further, the apparatus may include means for sending, in response to the failure report, instructions to the network element to perform an action to address the unfulfilled reliability.

Certain example embodiments described herein provide several technical improvements, enhancements, and/or advantages. In some example embodiments, it may be possible to fill the gap of the missing functionality of radio link capability exposure as a complementary solution to the CN side. It may also be possible to improve radio resource efficiency by taking into account the “weaker” link among all radio links involved in a UE-UE communication. Additionally, it may be possible to provide support for real E2E QoS monitoring from the RAN perspective. In addition, it may be possible to provide the achievable QoS to AF which can be used to further optimize the overall application and end user experience.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
5GCN 5G Core Network
5GS 5G System
AF Application Function
BS Base Station
CN Core Network
DL Downlink
DNN Data Network Name
E2E End-to-End
eNB Enhanced Node B
gNB 5G or Next Generation NodeB
IIoT Industrial Internet of Things
LTE Long Term Evolution
MCS Modulation Coding Scheme
NEF Network Exposure Function
NR New Radio
PDCP Packet Data Convergence Protocol
PDU Protocol Data Unit
PER Packet Error Rate
PRB Physical Resource Block
QoS Quality of Service
RLCR Radio Link Capability Report
RRC Radio Resource Control
SMF Session Management Function
S-NSSAI Single-Network Slice Selection Assistance Information
TB Transport Block
TSC Time Sensitive Communication
TSN Time Sensitive Network
UAS Unmanned Aerial Systems
UAV Unmanned Aerial Vehicle
UE User Equipment
UL Uplink
UPF User Plane Function
URSP UE Route Selection Policy
URLLC Ultra-Reliable Low-Latency Communications

1-47. (canceled)

48. An apparatus, comprising:
at least one processor; and
at least one memory comprising computer program code,
the at least one memory and the computer program code are configured, with the at least one processor to cause the apparatus at least to
receive, from a core network element, configuration of a reliability threshold for sending a failure report and/or a radio link capability report;
when the reliability threshold is reached, send a failure report, to the core network element, indicating that a required reliability cannot be fulfilled; and
receive instructions, from the core network element, to perform an action to address the unfulfilled reliability.

49. The apparatus according to claim 48, wherein the failure report comprises an indication that it is infeasible to further boost a reliability at a radio access network side.

50. The apparatus according to claim 48, wherein the at least one memory and the computer program code are further configured, with the at least one processor to cause the apparatus at least to:
generate the radio link capability report based on the reliability threshold configuration; and
send the radio link capability report along with the failure report.

51. The apparatus according to claim 50, wherein the radio link capability report is sent periodically without an explicit request from the core network element.

52. The apparatus according to claim 48, wherein the at least one memory and the computer program code are further configured, with the at least one processor to cause the apparatus at least to:
execute the instructions to perform the action to address the unfulfilled reliability,
wherein the action comprises at least one of
setting up duplicating legs,
setting up a duplicate session,
adjusting a duplication setting,
adjusting radio resource control configurations,
adjusting quality of service parameters,
adjusting allocation or parameterization of radio resources, or
adjusting allocation or parameterization of computing resources.

53. The apparatus according to claim 48, wherein the reliability threshold is configured as a static threshold, or as a dynamic threshold that is dynamically updated.

54. The apparatus according to claim 48, wherein the at least one memory and the computer program code are further configured, with the at least one processor to cause the apparatus at least to:
receive a request, from the core network element, for the failure report and/or the radio link capability report;
determine an achievable radio link capability in response to the request; and
send the radio link capability report, to the core network element, comprising information on the achievable radio link capability.

55. An apparatus, comprising:
at least one processor; and
at least one memory comprising computer program code,
the at least one memory and the computer program code are configured, with the at least one processor to cause the apparatus at least to
receive reliability criteria from a core network element;
configure a reliability threshold based on the reliability criteria;
send, to a network element, the configuration of the reliability threshold for sending a failure report and/or a radio link capability report;
receive a failure report, from the network element, indicating that a required reliability cannot be fulfilled;
send, in response to the failure report, instructions to the network element to perform an action to address the unfulfilled reliability.

56. The apparatus according to claim 55, wherein the action comprises at least one of:
setting up duplicating legs,
setting up a duplicate session,
adjusting a duplication setting,
adjusting radio resource control configurations,
adjusting quality of service parameters,
adjusting allocation or parameterization of radio resources, or
adjusting allocation or parameterization of computing resources.

57. The apparatus according to claim 55, wherein the at least one memory and the computer program code are further configured, with the at least one processor to cause the apparatus at least to:
receive the radio link capability report along with the failure report.

58. The apparatus according to claim 55, wherein the radio link capability report is received periodically without an explicit request for the radio link capability report.

59. The apparatus according to claim 55, wherein the at least one memory and the computer program code are further configured, with the at least one processor to cause the apparatus at least to:
identify a communication between a first user equipment and a second user equipment;
send a request for the radio link capability report to a network element serving the first user equipment, and to a network element serving the second user equipment;
receive respective radio link capability reports from the network element serving the first user equipment and from the network element serving the second user equipment; and
identify, based on the respective radio link capability reports, a weak communication link between a communication link of the first user equipment and a communication link of the second user equipment.

60. The apparatus according to claim 59, wherein the at least one memory and the computer program code are further configured, with the at least one processor to cause the apparatus at least to:
adjust, based on the respective radio link capability reports, a quality of service requirement for the first user equipment and the second user equipment by sending updated quality of service parameters to the network elements serving the first user equipment, and to the network element serving the second user equipment; or
adjust an overall quality of service requirement for the communication between the first user equipment and the second user equipment.

61. The apparatus according to claim 59, wherein the at least one memory and the computer program code are further configured, with the at least one processor to cause the apparatus at least to:
determine, based on the weak communication link, an achievable end-to-end performance.

62. The apparatus according to claim 55, wherein the reliability threshold is configured as a static threshold, or a dynamic threshold that is dynamically updated.

63. A method, comprising:
receiving reliability criteria from a core network element;
configuring a reliability threshold based on the reliability criteria;
sending, to a network element, the configuration of the reliability threshold for sending a failure report and/or a radio link capability report;
receiving a failure report, from the network element, indicating that a required reliability cannot be fulfilled;
sending, in response to the failure report, instructions to the network element to perform an action to address the unfulfilled reliability.

64. The method according to claim 63, wherein the action comprises at least one of:
setting up duplicating legs,
setting up a duplicate session,
adjusting a duplication setting,
adjusting radio resource control configurations,
adjusting quality of service parameters,
adjusting allocation or parameterization of radio resources, or
adjusting allocation or parameterization of computing resources.

65. The method according to claim 63, further comprising:
identifying a communication between a first user equipment and a second user equipment;
sending a request for the radio link capability report to a network element serving the first user equipment, and to a network element serving the second user equipment;
receiving respective radio link capability reports from the network element serving the first user equipment and from the network element serving the second user equipment; and
identifying, based on the respective radio link capability reports, a weak communication link between a communication link of the first user equipment and a communication link of the second user equipment.

66. The method according to claim 65, further comprising:
adjusting, based on the respective radio link capability reports, a quality of service requirement for the first user equipment and the second user equipment by sending updated quality of service parameters to the network elements serving the first user equipment, and to the network element serving the second user equipment; or
adjusting an overall quality of service requirement for the communication between the first user equipment and the second user equipment.

67. The method according to claim 65, further comprising:
determining, based on the weak communication link, an achievable end-to-end performance.
